(19) United States
(12) Patent Application Publication
(10) Pub. No.: US 2012/0121494 A1
(43) Pub. Date: May 17, 2012

(54) PROCESS FOR REACTIVATING SILICA SURFACES FOR THE ISOLATION OF NUCLEIC ACIDS

(75) Inventor: Markus Sprenger-Haus-Sels, Mettmann (DE)

(73) Assignee: QIAGEN GMBH

(21) Appl. No.: 13/321,464

(22) PCT Filed: May 20, 2010
(86) PCT No.: PCT/EP2010/056937

§ 371 Date: Jan. 30, 2012

(30) Foreign Application Priority Data
May 25, 2009 (DE) 10 2009 022 512.9

(51) Int. Cl. C01B 33/12

(52) U.S. Cl. 423/335

(57) ABSTRACT

The present invention relates to a process for increasing the binding capacity, in particular reactivation, of silica surfaces, in particular silica matrices, by treatment with water or an aqueous solution and also the use of water for reactivating silica membranes.

### FIELD OF THE INVENTION

The present invention relates to a method and a use for reactivating silica surfaces such as, for example, silica membranes, silica particles or columns with silica beds. The device and the use are, for example, suitable for applications in biochemistry, molecular biology, molecular genetics, microbiology, medical diagnostics, food safety testing or forensics.

### TECHNICAL BACKGROUND

Silica surfaces are, for example, widespread in the field of biochemistry, molecular biology, molecular genetics, microbiology, medical diagnostics, food safety testing or forensics and are usually used for separating, isolating and purifying biomolecules. A method which is often used is, for example, the use of silica membranes in isolating nucleic acids such as, for example, DNA or RNA.

For this purpose, the DNA and/or RNA which are to be isolated and are contained in a sample are bound to the silica membrane in the presence of, for example, a “chaotropic” reagent. The remaining constituents of the sample can then be removed by rinsing and washing. Subsequently, the DNA or RNA is released and analyzed.

As part of internal studies by the applicant, it has now become apparent that some silica matrices, more particularly commercially available silica membranes, exhibit the problem that in the case of particular membranes, the ability to bind nucleic acids sometimes decreases with (storage) time. This is particularly the case when they are stored at room temperature or higher temperatures. Although this problem can be greatly delayed by storage at 2-8° C. such that impairment of quality can be substantially eliminated up to the expiration date of the product, it should nevertheless be classified as disadvantageous.

### OBJECT OF THE PRESENT INVENTION

An object of the present invention is to at least largely overcome the described disadvantages arising from the prior art and, more particularly, to create, for a wide range of applications, a device and a use which increase the activity of silica surfaces, and more particularly can restore the activity of silica surfaces.

The object is achieved by a method as claimed in claim 1 of the present invention. Thus, a method for increasing the activity of silica surfaces, more particularly silica matrices such as, for example, silica membranes or silica particles, by treatment with an aqueous solution and/or water is proposed.

The object is likewise achieved by a use as claimed in claim 2 of the present invention. Thus, the use of water to increase the activity of silica surfaces, more particularly silica matrices such as, for example, silica membranes or silica particles, is proposed.

The term “aqueous solution” is understood to mean in particular a solution which consists of ≧80% by weight, preferably ≧90% by weight, more preferably ≧95% by weight, particularly preferably ≧98% by weight, very particularly preferably ≧99% by weight, and most preferably ≧99.5% by weight, of water.

The term “activity” is understood to mean in particular the ability to bind and/or immobilize nucleic acids.

For the purposes of the present invention, the term “nucleic acid” is understood to mean in particular—but is not limited thereto—natural, preferably linear, branched or circular nucleic acids such as RNA, more particularly mRNA, single-stranded and double-stranded viral RNA, siRNA, miRNA, snRNA, snoRNA, scaRNA, tRNA, hnRNA or ribozymes, genomic, bacterial or viral DNA (single-stranded and double-stranded), chromosomal and episomal DNA, free-circulating nucleic acid and the like, synthetic or modified nucleic acids, for example oligonucleotides, more particularly primers, probes or standards used in PCR, digoxigenin-, biotin- or fluorescent dye-labeled nucleic acids or what are known as PNAs (peptide nucleic acids).

For the purposes of the present invention, the term “immobilization” is understood to mean in particular—but is not limited thereto—reversible immobilization on a suitable solid phase.

The term “increase” is understood to mean in particular, and in a preferred embodiment of the invention, reactivation.

The term “silica surfaces” is understood to mean in particular—but is not limited thereto—silica matrices such as, for example, silica membranes, silica particles as a loose bed, silica-coated magnetic, paramagnetic, ferromagnetic or superparamagnetic particles or silica fibers.

The term “silica membranes” is understood to mean in particular—but is not limit thereto—membranes with incorporated silica fibers, incorporated silica gel, membrane-integrated or membrane-associated silica in any other form.

Such a method offers at least one of the following advantages for a wide range of applications within the context of the present inventions:
Activity is increased, more particularly the matrix (e.g. membrane) is reactivated, by means of a simple step under very mild conditions.
For most applications within the context of the present invention, reactivation is even complete to such an extent that it is possible to dispense with storage at cold temperatures.
The reactivation step can ensure that the quality and function of the matrices (particularly in the form of columns) remain constant.
Reproducibility in the applications rises significantly as a result.

It should be pointed out that the method according to the invention is all the more surprising because it can be used particularly with silica matrices which are used for binding/immobilizing nucleic acids. The conditions under which binding/immobilization takes place are normally such that
use is made of a chaotropic reagent whose effect involves, inter alia, destroying the hydration envelope around the nucleic acids; and
immobilization is carried out under dehydrating conditions (e.g., by using alcohol as solvent).

Thus, although the water is not completely eliminated during the immobilization, the hydration envelope around the nucleic acid is at least largely removed. It is all the more surprising that the restoration or increase in activity (=immobilization ability) of the silica matrices occurs under the simple conditions according to the invention.

Treatment with water or an aqueous solution preferably lasts ≧5 minutes, more preferably ≧10 minutes, particularly preferably ≧15 minutes, very particularly preferably ≧30 minutes. In principle, the duration of treatment has no upper limit, but it has been found in most applications that treatment for longer than 60 minutes (in many cases, longer than 45 minutes) does not bring about any further substantial increase in activity. Thus, the preferred duration of treatment is between 15 and 60 minutes, particularly preferably between 30 and 45 minutes.

In principle, it is preferred that treatment with water or an aqueous solution is carried out within a short space of time, particularly preferably immediately (interrupted only by wash steps, if any, etc.), prior to the planned use of the silica matrix, as this maximizes the effect achieved.

In addition, treatment with water or an aqueous solution preferably takes place at a temperature of 0° C., 1° C., 2° C., 3° C., 4° C., 5° C., particularly preferably at ≧5° C. In principle, the temperature of the treatment has no upper limit, but it has been found in most applications that treatment at a temperature of up to ≦45° C. makes handling easiest, with the temperature range of ≧20° C. to ≦30° C. being preferred. Ideally, temperatures are 21, 22, 23, 24, 25, 26, 27, 28 or 29° C., with treatment at room temperature being preferred.

An aqueous solution used for the treatment according to the invention can additionally contain one or more components selected from the group of
buffer substances, in particular—but not limited thereto—Tris, Tris/HCl, HEPES, MOPS, sodium acetate buffer, phosphate buffer, ammonium acetate buffer
salts, for example, but not exclusively, halides, chlorides, more particularly NaCl, KCl, MgCl₂, CaCl₂, MnCl₂, ammonium acetate, magnesium acetate and other acetates, sulfates, sulfites, phosphates, phosphites, carbonates, nitrates, nitrites
stabilizers, in particular chelators such as, for example, EDTA, EGTA, NTA, EDDHA, DTPA, HEEDTA
preservatives, in particular, but not limited to, sodium azide, ProClin, sorbic acid, sorbates, benzoates
detergents, for example, but not exclusively, Triton, SDS, Tween, Brij or others
   and mixtures thereof.

However, it has been found that, surprisingly, the addition of relatively large amounts of chaotropic reagents reduces activation. Thus, the aqueous solution preferably has no chaotropic reagents or only low concentrations of chaotropic reagents (preferably ≦100 mM, particularly preferably ≦10 mM, very particularly preferably ≦1 mM).

In addition, the aqueous solution used for the treatment according to the invention has a pH of 1, 2, 3, 4, 5, 6, 7, 8, 9 or 10. Preferably, the aqueous solution has a pH of ≧2 to ≦9.5, preferably ≧4 to ≦9, particularly preferably ≧5 to ≦8.5, very preferably ≧6 to ≦8, and is most preferably essentially neutral.

The components to be used according to the invention, mentioned above and also claimed and described in the exemplary embodiments, are not subject to any particular exclusion conditions with regard to their size, shape, material selection and technical conception, and so the selection criteria known in the field of application can be applied without restriction.

Further details, features and advantages of the subject matter of the invention arise from the dependent claims and also from the description below of the accompanying figures and examples in which—by way of example—multiple embodiments and possible uses of the present invention are illustrated.

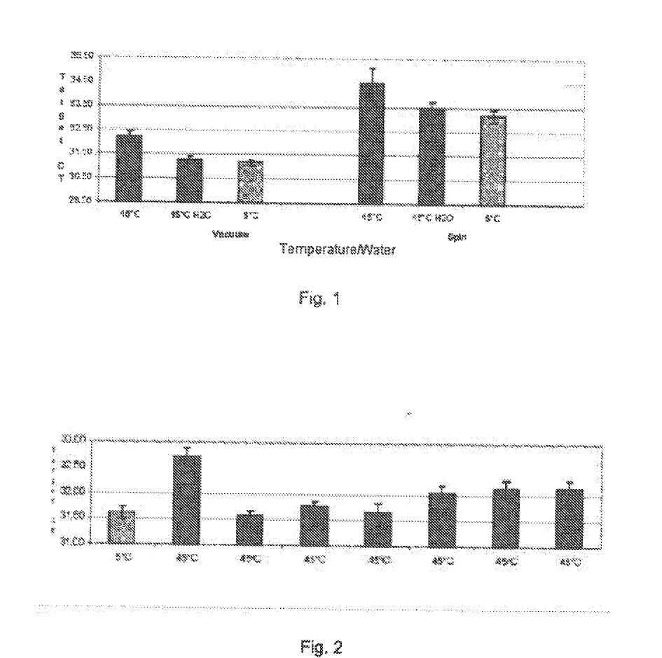

FIG. 1 shows the activity of various silica matrices after storage for 3 weeks at different temperatures and subsequent treatment according to the invention with water.

FIG. 2 shows the activity of various silica matrices after storage for 3 weeks and subsequent treatment according to the invention with different aqueous solutions.

### EXAMPLE 1

### Determining the Activity of Silica Matrices after Storage for 3 Weeks at Different Temperatures and Subsequent Treatment According to the Invention with Water

The following procedure was adopted:

Multiple QIAamp MinElute columns (from QIAGEN) were stored for 3 weeks at 45° C., and reference columns (of the same lot number) were stored in parallel at 5° C.

Half of the columns stored at 45° C. were each preincubated for 30 min with water at room temperature prior to use.

Subsequently, the activity of the columns was measured.

For this purpose, human plasma admixed with hepatitis B virus [10e4 c/ml HBV] was processed/purified as sample using the “Vacuum” protocol (QIAamp MinElute Virus Vacuum Handbook, 3rd edition, March 2007) or the “Spin” protocol (QIAamp MinElute Virus Spin Handbook, 3rd edition, February 2007).

The purified nucleic acid (double-stranded, circular DNA) was quantified by means of HBV-specific real-time PCR. The amount of isolated HBV DNA can be used as a measure of the binding activity of the column. Low Ct values (threshold cycle; PCR cycle in which the nucleic acid is first detectable) are evidence of greater binding activity; higher Ct values demonstrate reduced binding capacity.

The activity measurement is shown in FIG. 1. The activity of the column stored at 45° C., the activity of the column stored at 45° C. and subsequently treated according to the invention with water (45° C., H₂O), and, as control, the activity of the column stored at 5° C. are each shown.

The results show that, compared to the columns stored at 5° C. (in which activity does not decrease), aging of the columns stored at 45° C. leads to a shift of about 1 Ct (i.e., to a binding capacity reduced by about 50%) after 3 weeks.

By contrast, pretreatment of the columns stored at 45° C. (45° C./H₂O) shows that, surprisingly, aging can be completely reversed. Columns stored at 45° C. which were treated according to the invention prior to use thus exhibit the same performance as columns which were stored at a cool temperature, i.e., at 5° C.

### EXAMPLE 2

### Determining the Activity of Silica Matrices after Storage for 3 Weeks and Subsequent Treatment According to the Invention with Different Aqueous Solutions

As in example 1, multiple QIAamp MinElute columns were stored for 3 weeks at 45° C., and reference columns (of the same lot number) were stored in parallel at 5° C.

Prior to measurement of activity, multiple columns were incubated with each of the following solutions for 30 min at room temperature:

| | |
|---|---|
| Solution 1 | 0.04% Sodium azide in water, pH 6 |
| Solution 2 | 10 mM Tris/HCl (pH 8.5) in water |
| Solution 3 | 10 mM Tris/HCl (pH 9.0), 0.5 mM EDTA in water |
| Solution 4 | 10 mM Tris/HCl (pH 8.0), 10 mM KCl, 2 mM EDTA, |
| | 2% Triton X-100, 14.5 mM MgCl₂ in water |
| Solution 5 | 50 mM NaOAc, pH 5.1, 5M GITC, 0.1M xylitol, 3% |
| | Cresol Red in water |
| Solution 6 | 50 mM MOPS, pH 7.0, 750 mM NaCl, 0.15% Triton X- |
| | 100, 15% isopropanol |

Subsequently, binding activity human plasma admixed with HBV [10e4 c/ml HBV] was—as described in example 1—purified according to the Vacuum protocol, and the purified nucleic acid (double-stranded, circular DNA) was quantified by means of HBV-specific real-time PCR.

As control (C), the respective activities of the columns stored at 45° C. and at 5° C. were also determined.

The results are shown in FIG. 2. It can be seen that, in principle, treatment of the silica matrix with all the aqueous solutions according to the invention results in reactivation.

1. A method for increasing the activity of silica surfaces by treatment with an aqueous solution and/or water.

2. The method as claimed in claim 1, wherein silica surfaces are used for the immobilization of nucleic acids.

3. The method as claimed in claim 1, wherein the method is used to reactivate silica surfaces.

4. The method as claimed in claim 1, wherein the treatment lasts ≧5 minutes.

5. The method as claimed in claim 1, wherein the treatment takes place at a temperature of ≧0° C.

6. The method as claimed in claim 1, wherein the aqueous solution used for the treatment has a pH of ≧1 to ≦10.

7. The use of an aqueous solution and/or water to increase the activity of silica surfaces.

8. The use as claimed in claim 8, wherein the aqueous solution consists of ≧80% by weight of water.
